(19) United States
(12) Patent Application Publication
(10) Pub. No.: US 2025/0278668 A1
(43) Pub. Date: Sep. 4, 2025

(54) PARALLEL JOIN APPLICATION FOR MACHINE LEARNING FEATURES

(71) Applicant: NETFLIX, INC., Los Gatos, CA (US)

(72) Inventors: Patrick Oscar BOYKIN, Paia, HI (US); Jorge VICENTE CANTERO, San Mateo, CA (US); Tomás LÁZARO, San Francisco, CA (US); Aaron M. LEWIS, San Francisco, CA (US)

(21) Appl. No.: 18/593,831

(22) Filed: Mar. 1, 2024

(51) Int. Cl. G06N 20/00

(52) U.S. Cl. CPC G06N 20/00

(57) ABSTRACT

One embodiment of the present invention sets forth a technique for generating a value for a machine learning feature. The technique includes receiving a machine learning feature and a context, generating a plurality of distinct sub-contexts based on the context, and assigning each of the plurality of sub-contexts to a different feature value engine of a plurality of feature value engines. The technique also includes assigning, via parallel operation of the plurality of feature value engines, intermediate values based on the plurality of sub-contexts, receiving, from the plurality of feature value engines, the intermediate values, aggregating the intermediate values to generate a value for the machine learning feature, and transmitting the generated machine learning feature value to a requesting entity.

### BACKGROUND

### Field of the Various Embodiments

Embodiments of the present disclosure relate generally to machine learning and, more specifically, to techniques for generating features for use with one or more machine learning models.

### Description of the Related Art

Machine learning techniques include providing values for one or more features as input variables to one or more machine learning models. Feature values may be derived from a context associated with the feature. A context may include contextual elements associated with a user, for example, a user's location, a user's profile, a time of day, an identification number associated with a user's device, or the user's current Internet Protocol (IP) address. Feature values may also be based on or derived from combinations of contextual elements, other feature values, and/or historical data, such as whether an individual user has previously performed a particular action at a specific location or at a specific time of day. Machine learning techniques may train a machine learning model by repeatedly providing a combination of feature values to the model while adjusting the parameters of the model until the model's output matches known correct outputs for the combination of input feature values within acceptable limits. A trained machine learning model may subsequently infer an output given a combination of input feature values.

Machine learning techniques may contemplate thousands or millions of different features and may provide values for all or a subset of those features to a machine learning model in a large variety of possible combinations. For each feature provided to a machine learning model, a machine learning technique retrieves a value for the feature and provides the retrieved feature value to the machine learning model.

Existing machine learning methods may naively generate various possible sub-contexts, where each sub-context includes one or more specific contextual elements, such as a user profile, a user profile and a time of day, or a user profile and a user location. The machine learning methods then sequentially process each sub-context, retrieve intermediate values associated with the sub-context, and generate a value for a requested machine learning feature. Sequentially processing sub-contexts and generating intermediate values associated with each sub-context may require an unacceptable amount of time and result in excessive latency that prevents real-time or near real-time execution of the machine learning methods in an interactive session with a user.

Furthermore, sequentially generating different sub-contexts and retrieving values for features associated with each sub-context also hinders the creation of large training data sets of recent training data for model training. In particular, sequentially generating sub-contexts and retrieving feature values associated with each sub-context increases the total time needed to create the training data sets. As a result, training data sets may include older, stale data. Consequently, generating up-to-date training data sets representative of a large variety and combination of features is often not possible given this computational complexity.

As the foregoing illustrates, what is needed in the art are more effective techniques for generating features for use with machine learning models.

### SUMMARY

One embodiment of the present invention sets forth a technique for assigning values to machine learning features. The technique includes receiving, from a requesting entity, a feature request including a machine learning feature and an associated context. The technique generates a plurality of distinct sub-contexts based on the context. The technique also includes assigning each of the plurality of sub-contexts to a different feature value engine of a plurality of feature value engines.

In response to a received event and via parallel operation of the plurality of feature value engines, the technique generates one or more intermediate features based on the sub-contexts. The technique further includes receiving, from the plurality of feature value engines, the generated intermediate values, aggregating the intermediate values to generate a value for the machine learning feature included in the feature request, and transmitting the machine learning feature and the generated value to the requesting entity.

One technical advantage of the disclosed technique relative to the prior art is that the implementation processes sub-contexts in parallel, retrieving feature values for features associated with each of the sub-contexts simultaneously rather than sequentially. This parallel processing reduces the total time needed to retrieve feature values for features associated with the various sub-contexts based on an event, decreasing both the latency during operation and the time required to generate training data libraries for model training. These technical advantages provide one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a network infrastructure configured to implement one or more aspects of the various embodiments.

FIG. 2 is a more detailed illustration of feature join engine 130 of FIG. 1 according to various embodiments.

FIG. 3 is a flow diagram of method steps for performing parallel feature join according to various embodiments.

FIG. 4 is a block diagram of a computing device on which feature join engine 130 of FIG. 1 may be implemented, according to various embodiments.

FIG. 5 illustrates a second network infrastructure configured to implement one or more aspects of the various embodiments.

FIG. 6 is a block diagram of content server 510 that may be implemented in conjunction with the network infrastructure of FIG. 5, according to various embodiments.

FIG. 7 is a block diagram of control server 520 that may be implemented in conjunction with the network infrastructure of FIG. 5, according to various embodiments.

FIG. 8 is a block diagram of endpoint device 515 that may be implemented in conjunction with the network infrastructure of FIG. 5, according to various embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

Machine learning techniques include providing values for one or more machine learning features as input variables to one or more machine learning models. Machine learning features are individual measurable properties or characteristics of a system or phenomenon and are presented as inputs to a machine learning model (e.g., a neural network). Feature values may be derived from a context that includes contextual elements associated with a user, for example, a user's location, a user's profile, a time of day, an identification number associated with a user's device, or the user's current Internet Protocol (IP) address. Feature values may also be based on or derived from combinations of contextual elements, other feature values, and/or historical data, such as whether an individual user has previously performed a particular action at a specific location or at a specific time of day. Machine learning techniques may train a machine learning model by repeatedly providing a combination of feature values to the model while adjusting the parameters of the model until the model's output matches known correct outputs for the combination of input feature values within acceptable limits. A trained machine learning model may subsequently infer an output given a combination of input feature values.

Machine learning techniques may contemplate thousands or millions of different features and may provide values for all or a subset of those features to a machine learning model in a large variety of possible combinations. For each feature provided to a machine learning model, a machine learning technique retrieves a value for the feature and provides the retrieved feature value to the machine learning model.

Existing machine learning methods may naively generate various possible sub-contexts, where each sub-context includes one or more specific contextual elements, such as a user profile, a user profile and a time of day, or a user profile and a user location. The machine learning methods then sequentially process each sub-context to retrieve intermediate values associated with the sub-context. The methods then generate feature values based on the intermediate values associated with the various sub-contexts. Sequentially processing sub-contexts and retrieving intermediate values associated with each sub-context may require an unacceptable amount of time and result in excessive latency that prevents real-time or near real-time execution of the machine learning methods in an interactive session with a user.

Furthermore, sequentially generating different sub-contexts and retrieving intermediate values associated with each sub-context also hinders the creation of large training data sets for model training. In particular, lag or latency from sequentially generating sub-contexts and retrieving intermediate values associated with each sub-context increases the total time needed to create the training data sets. As a result, training data sets may include older, stale data. Consequently, generating up-to-date training data sets representative of a large variety and combination of features is often not possible given this computational complexity, leading to potentially suboptimal performance in models trained on the training data sets.

In order to reduce latency associated with the sequential generation of intermediate values and to facilitate the creation of large training data sets for model training, the disclosed techniques may be used to retrieve intermediate values in parallel. In some embodiments, with the disclosed techniques, a request engine receives a feature request from a requesting entity, where the feature request includes a machine learning feature and a context. The request engine transmits the feature request to a partitioning engine, and the partitioning engine generates one or more sub-contexts. Each sub-context includes a distinct combination of one or more contextual elements from the context. Each sub-context contains one or more contextual elements necessary for generating intermediate values that will be aggregated to generate a value for the machine learning feature included in the feature request. The partitioning engine may generate a sub-context for every possible combination of contextual elements, except for the degenerate case of a sub-context that contains no contextual elements. Thus, for an event having a context that contains N contextual elements, the partitioning engine may generate up to 2^{N}−1 distinct sub-contexts. The partitioning engine records the number of sub-contexts generated for the event request, assigns a different sub-context to each of one or more feature value engines, and transmits each of the assigned sub-contexts to its associated feature value engine.

The request engine further receives an event from a computing system such as a streaming service. Examples of events include the presentation of a content item to a user, a search request submitted by a user, or a user logging into or out of a service. An event also includes one or more contextual elements associated with the event.

The request engine randomly generates a unique event ID for the event and transmits the event and the event ID to each of the feature value engines via the partitioning engine. The partitioning engine transmits the event request, including the event ID and the event data from which the feature value engine may derive the sub-context intermediate value, to each of the feature value engines. The feature value engines process event in parallel, and each feature value engine generates intermediate values that are based on or derivable from the contextual elements included in the sub-context assigned to the feature value engine. When generating intermediate values, each feature value engine may request historical data from a data store including feature data sets. Further, each feature value engine may perform calculations or conditional logic necessary to generate a feature value for a feature.

When a feature value engine completes generating intermediate values associated with the sub-context assigned to the feature value engine, the feature value engine transmits the results, including the generated intermediate values, the associated sub-context elements, and the associated event ID to the partitioning engine. The partitioning engine receives the transmitted results from each feature value engine.

When all of the feature value engines have returned their results for an event ID, the partitioning engine aggregates the results to generate a value for the requested machine learning feature and transmits the online feature value to the request engine. The request engine transmits the online feature value to the requesting entity. The partitioning engine determines that all of the feature value engines have returned their results for a given event ID when the number of feature value engines that have returned results associated with the event ID is equal to the number of generated sub-contexts associated with the machine learning feature included in the feature request. The request engine may receive and process additional events, updating the value of the machine learning feature included in the feature request based on each additional event.

The disclosed techniques may generate feature values to be used as input to a trained machine learning model so that the trained machine learning model may perform an inference operation. The disclosed techniques may also retrieve historical feature values associated with a particular time. The disclosed techniques may generate, based on the historical feature values, a training data set of labeled or unlabeled scenario data for the purpose of training one or more machine learning models.

One technical advantage of the disclosed technique relative to the prior art is that the implementation processes sub-contexts in parallel, retrieving intermediate values for features associated with each of the sub-contexts simultaneously rather than sequentially. This parallel processing reduces the total time needed to retrieve intermediate values for features associated with the various sub-contexts, decreasing latency in user-interactive machine learning models that take these feature values as input. Parallel processing of sub-contexts also reduces the time required to generate training data libraries for model training, permitting more recent and/or relevant training data to be included in a model. These technical advantages provide one or more technological improvements over prior art approaches.

### System Overview

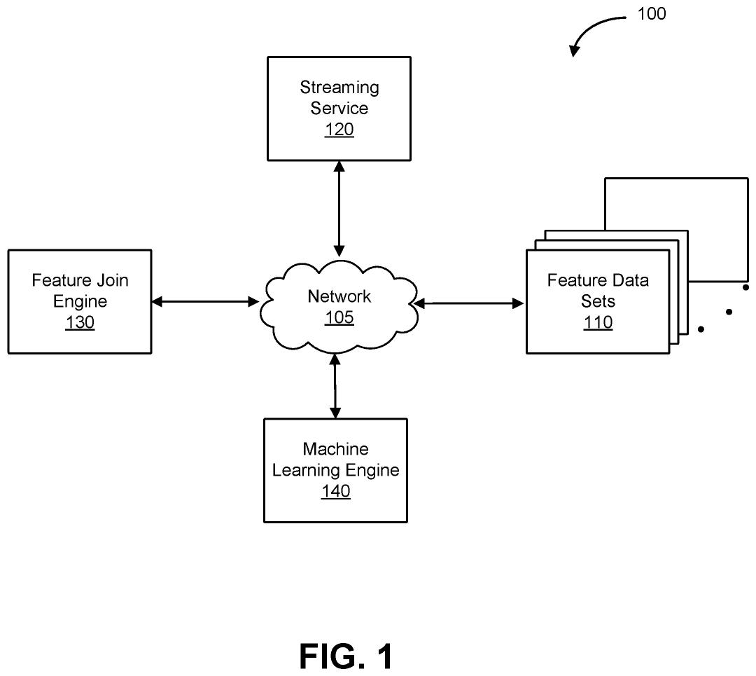

FIG. 1 illustrates a network infrastructure configured to implement one or more aspects of the various embodiments. As shown, network infrastructure 100 includes without limitation a streaming service 120, one or more feature data sets 110, a feature join engine 130, and a machine learning engine 140, which are connected to one another via a communications network 105.

Feature join engine 130 receives a request for a machine learning feature value from a requesting entity. Machine learning features are individual measurable properties or characteristics of a system or phenomenon and are presented as inputs to a machine learning model (e.g., a neural network). In various embodiments, the requesting entity may be a software or hardware application, such as machine learning engine 140 or streaming service 120 described below. A request may include a machine learning feature and a context associated with the request. The context may include one or more contextual elements such as a user's location, a user's profile, a time of day, an identification number associated with a user's device, or the user's current Internet Protocol (IP) address. For example, a requesting entity may request a value for a machine learning feature “f1”. The request may be expressed as “Feature[(K1, K2, K3), V]” denoting that the feature (f1) depends upon values of contextual elements K1, K2, K3, either alone or in combination, and ‘V’ is the value that feature join engine 130 returns for machine learning feature “f1”

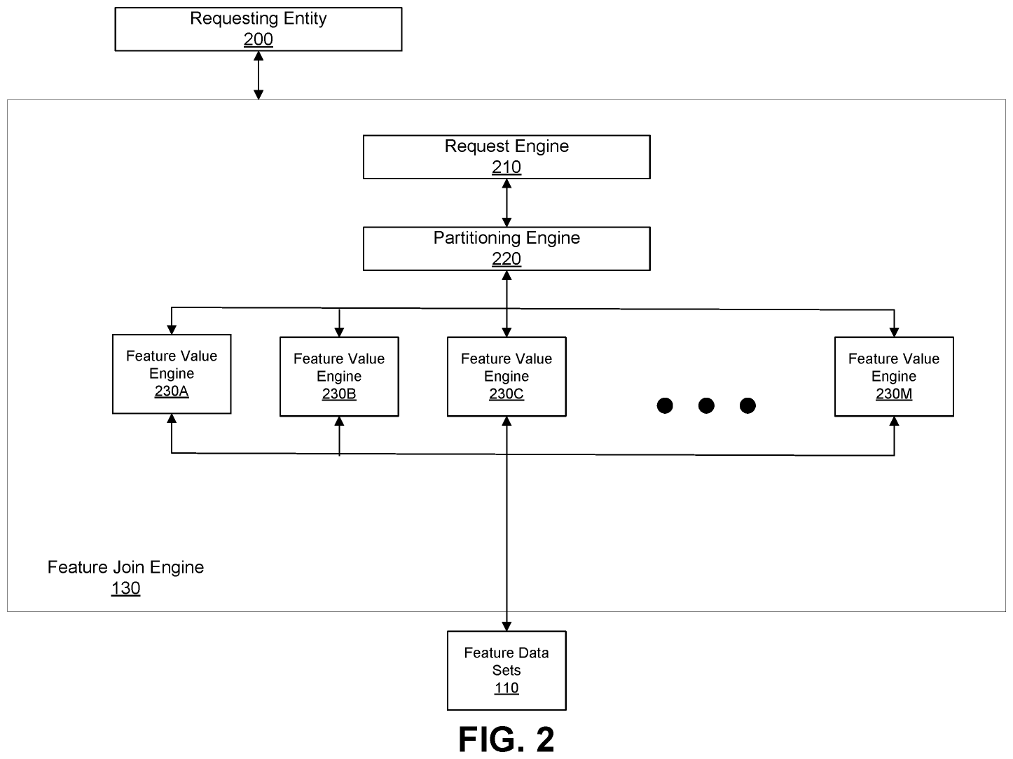

Feature join engine 130 generates a value to the requested machine learning feature in response to an event received from a computing system such as streaming service 120 discussed below and returns the machine learning feature and associated value to the requesting entity. Feature join engine 130 determines intermediate values necessary to generate a value for the requested machine learning feature based on data stored in one or more of feature data sets 110 described below. Feature join engine 130 is described in more detail in the description of FIG. 2 below.

Streaming service 120 provides items of multimedia content to a variety of users, such as customers or subscribers of the streaming service. Streaming service 120 may include one or more machine learning models trained to generate inferences associated with items of multimedia content or users of streaming service 120. For instance, a trained machine learning model included in streaming service 120 may generate an inference representing a probability that a given user will choose to view a given item of multimedia content that is presented to the user. For each trained machine learning model in streaming service 120, streaming service 120 determines a plurality of machine learning features to present as input to the trained machine learning model such that the machine learning model may generate a desired inference. Streaming service 120 also generates a context of one or more contextual features relevant to the machine learning feature. Streaming service 120 transmits a request as described above to feature join engine 130, including the machine learning feature and the associated context. Streaming service 120 receives the machine learning feature value assigned by feature join engine 130.

Machine learning engine 140 generates training data sets for training one or more machine learning models, such as the machine learning models included in streaming service 120 described above. Machine learning engine 140 transmits a machine learning feature and a context to feature join engine 130, and feature join engine 130 returns a value for the machine learning feature based on one or more received events. In various embodiments, the context may include a timestamp referencing a historical point in time. In such embodiments, the machine learning feature value returned by feature join engine 130 may represent the machine learning feature value at the historical point in time referenced by the timestamp. Machine learning engine 140 includes the returned machine learning feature value as an element of ground truth labeled or unlabeled training data in a generated training data set.

Feature data sets 110 may store data associated with users of streaming service 120. Feature data sets 110 may also store data associated with items of multimedia content associated with streaming service 120. Feature data sets 110 may further store data associated with the operation of streaming service 120, including user actions or items of multimedia content presented or suggested to a user. Data stored in feature data sets 110 may include an associated timestamp, such as a timestamp indicating a time that a particular user viewed a particular item of multimedia content. Feature join engine 130 may query feature data sets 110 when assigning machine learning feature values to machine learning features. Feature data sets 110 may provide current and/or historical data to feature join engine 130 as requested.

In various embodiments, feature data sets 110 may include file servers, hard disk drives, solid state storage devices, or similar storage devices. Feature data sets 110 may also include an online storage service in which a catalog of files, including thousands or millions of files, is stored and accessed in order to exchange data with the various components in network infrastructure 100. As shown in FIG. 1, various embodiments of the present disclosure may implement multiple instances of feature data sets 110.

Network 105 includes any technically feasible wired, optical, wireless, or hybrid network that transmits data between or among streaming service 120, feature join engine 130, feature data sets 110, machine learning engine 140, and/or other components. For example, network 105 could include a wide area network (WAN), local area network (LAN), personal area network (PAN), WiFi network, cellular network, Ethernet network, Bluetooth network, universal serial bus (USB) network, satellite network, and/or the Internet.

FIG. 2 is a more detailed illustration of the feature join engine of FIG. 1 according to various embodiments. As shown, feature join engine 130 includes request engine 210, partitioning engine 220, one or more feature value engines 230(A-M), and events 240.

Feature join engine 130 receives, via request engine 210, a feature request transmitted by requesting entity 200, where the feature request includes a machine learning feature and a context associated with the machine learning feature. In various embodiments, requesting entity 200 may be a human user or an upstream application such as streaming service 120 or machine learning engine 140 described above in reference to FIG. 1. Machine learning features may be associated with one or more users of streaming service 120 or one or more items of multimedia content associated with streaming service 120. Machine learning features may further be associated with operations of streaming service 120 such as whether streaming service 120 has previously presented a particular item of multimedia content to a particular user. Machine learning features may also be based on or derived from combinations of context, other feature values, and/or historical data, such as whether an individual user has previously performed a particular action at a specific location or at a specific time of day.

The context includes one or more contextual elements, such as a user's location, a user's profile, a time of day, an identification number associated with a user's device, or the user's current Internet Protocol (IP) address. The context may also include a timestamp referencing a historical point in time. For example, as discussed above, a requesting entity may request a value for a machine learning feature “f1”. The request may be expressed as “Feature[(K1, K2, K3), V]” denoting that the feature (f1) depends upon values of contextual elements K1, K2, K3, either alone or in combination, and ‘V’ is the value that feature join engine 130 returns for machine learning feature “f1”

Partitioning engine 220 receives the feature request from request engine 210. Based on the contextual elements included in the received context, partitioning engine 220 generates a plurality of sub-contexts. A sub-context is a subset of the context and includes one or more contextual elements necessary for feature values 230 to generate one or more intermediate values. Partitioning engine 220 may generate a distinct sub-context for every possible combination of one or more contextual elements included in the context. Thus, for an event having a context that includes N contextual elements, partitioning engine 220 may generate up to 2^{N}−1 distinct sub-contexts. For example, partitioning engine may receive context elements K1, K2, and K3 as described above and generate three sub-contexts, where one sub-context includes the contextual element (K1), another sub-context includes the contextual elements (K2,K3), and the third sub-context includes the contextual elements (K1,K2). Partitioning engine 220 records the number of sub-contexts generated for the feature request, assigns a different sub-context to each of feature value engines 230, and transmits each of the assigned sub-contexts to its associated feature value engine 230(A-M).

Request engine 210 further receives an event 240 from a computing system such as streaming service 120. Examples of events 240 include the presentation of a content item to a user, a search request submitted by a user, or a user logging into or out of a service. An event 240 includes one or more contextual elements associated with the event, along with values for the one or more contextual elements. Request engine 210 randomly assigns a unique event ID to the event 240. Request engine 210 transmits the event ID, the contextual elements, and the associated values to partitioning engine 220. Partitioning engine 220 transmits the event ID, the contextual elements, and the associated values to each of feature value engines 230.

Each feature value engine 230(A-M) receives its assigned distinct sub-context from partitioning engine 220. Upon receipt of an event ID and data associated with the event ID, feature value engines 230 operate in parallel to collectively assign intermediate values based on the contextual elements included in the sub-contexts and the data associated with the event ID. Each feature value engine 230(A-M) assigns intermediate values based on the contextual elements included in its assigned sub-context. For instance, a feature value engine 230(A-M) may determine intermediate values based on the contextual elements “user profile” and “time of day” in its assigned sub-context.

Each feature value engine 230(A-M) queries feature data sets 110 to retrieve values or perform computations based on the contextual elements included in its sub-context. Each feature value engine 230(A-M) may retrieve an intermediate value directly from data stored in feature data sets 110 or may perform conditional and/or computational operations on data stored in feature data sets 110 to derive an intermediate value. For example, a feature value engine 230(A-M) may determine an intermediate value for the contextual element “subscriber join date” by explicitly querying feature data sets 110 for that particular value. Alternatively, a feature value engine 230(A-M) may determine an intermediate feature value for the contextual element “time since user's last login” by querying feature data sets 110 for the date of the user's most recent login and then calculating a time interval between that date and the current date.

When feature value engine 230(A-M) has completed assigning intermediate values based on its assigned sub-context And event 240, the feature value engine 230(A-M) returns the sub-context and intermediate values to partitioning engine 220. Feature value engine 230(A-M) also returns the event ID associated with the event 240 to partitioning engine 220.

Partitioning engine 220 determines that all of the feature value engines 230 have returned their results for a given event ID when the number of feature value engines 230 that have returned results associated with the event ID is equal to the number of generated sub-contexts associated with machine learning feature. When all of feature value engines 230 have returned their results for an event ID, partitioning engine 220 aggregates the results, generates a value for the requested machine learning feature and transmits the machine learning feature value to request engine 210. Request engine 210 transmits the results to requesting entity 200. The results include the machine learning feature, the context, and the machine learning feature value generated by partitioning engine 220. Request engine 220 may receive and process additional events 240 as described above and repeatedly update the value of the machine learning feature included in the feature request based on each additional event 240.

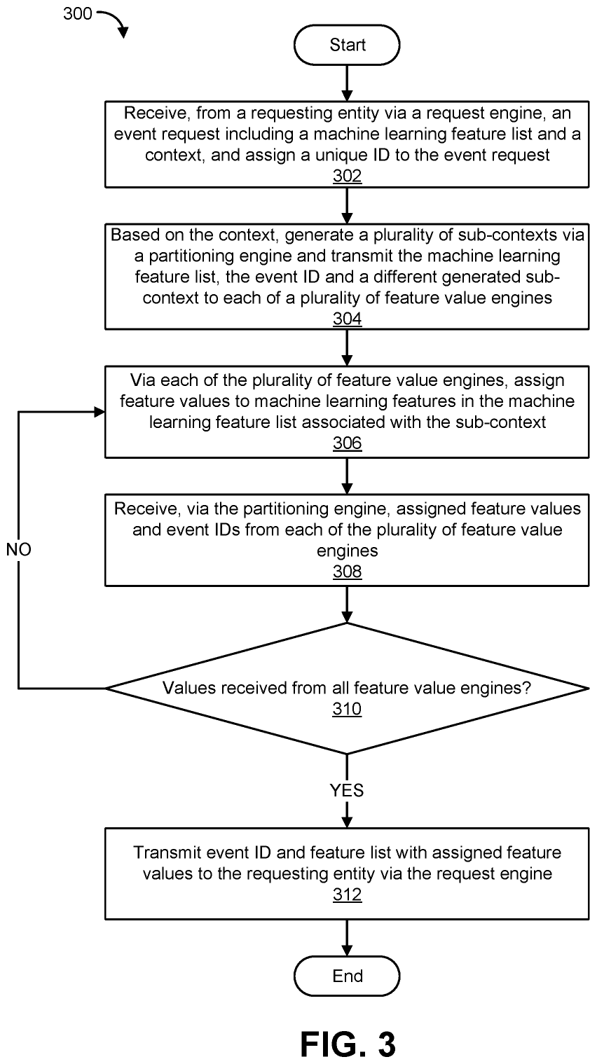

FIG. 3 is a flow diagram of method steps for performing parallel feature join according to various embodiments. Although the method steps are described in conjunction with the systems of FIGS. 1-2, persons skilled in the art will understand that any system configured to perform the method steps, in any order, is within the scope of the present invention.

As shown, method 300 begins at step 302, where feature join engine 130 receives a feature value request from requesting entity 200 via request engine 210. The feature value request includes a machine learning feature and a context. The context includes a plurality of contextual elements.

At step 304, feature join engine 130 generates, via partitioning engine 220, a plurality of sub-contexts based on the contextual elements included in the context. Feature join engine 130 may generate a distinct sub-context for every possible combination of one or more contextual elements included in the context. Feature join engine 130 transmits a different assigned sub-context to each of a plurality of feature value engines 230.

At step 305, request engine 210 receives an event from a computing system such as streaming service 120 and randomly generates a unique event ID associated with the event. The event includes one or more contextual elements as event data. Request engine 210 transmits the Event ID and event data to each of the plurality of feature value engines 230.

At step 306, feature join engine 130 generates, via the parallel operation of the plurality of feature value engines 230, intermediate values based on contextual elements included in each sub-context. Each feature value engine 230(A-M) queries feature data sets 110 and generates one or more intermediate values based on its assigned sub-context and the contents of feature data sets 110.

At step 308, feature join engine receives, via partitioning engine 220, assigned intermediate values and event IDs from each of feature value engines 230.

At step 310, feature join engine 130 determines, via partitioning engine 220, whether all of feature value engines 230 have returned their results for a given event ID. If the number of feature value engines 230 that have returned results associated with the event ID is equal to the number of generated sub-contexts associated with the requested machine learning feature, then the method proceeds to step 312. If not all of feature value engines 230 have returned their results for the event ID, the method returns to step 306.

At step 312, feature join engine 130 transmits, via request engine 210, the machine learning feature and the associated machine learning feature value to requesting entity 200. Feature join engine may return to step 305 to process additional events.

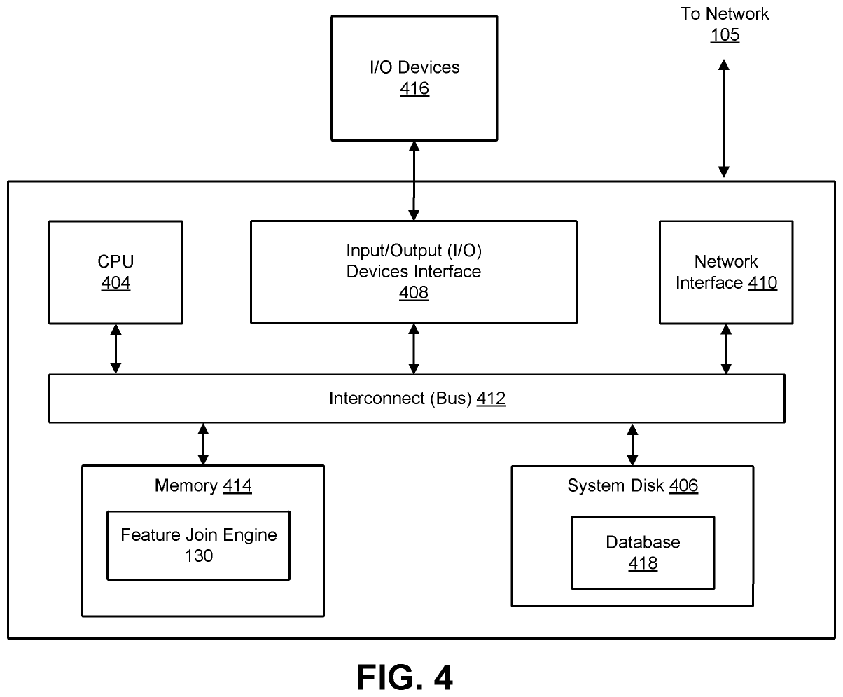

FIG. 4 is a block diagram of a computing device on which feature join engine 130 of FIG. 1 may be implemented, according to various embodiments. As shown, the computing system includes, without limitation, a central processing unit (CPU) 404, a system disk 406, an input/output (I/O) devices interface 408, a network interface 410, an interconnect 412, and a system memory 414.

CPU 404 is configured to retrieve and execute programming instructions stored in system memory 414. Similarly, CPU 404 is configured to store application data (e.g., software libraries) and retrieve application data from system memory 414 and a database 418 stored in system disk 406. Interconnect 412 is configured to facilitate transmission of data between CPU 404, system disk 406, I/O devices interface 408, network interface 410, and system memory 414. I/O devices interface 408 is configured to transmit input data and output data between I/O devices 416 and CPU 404 via interconnect 412. System disk 406 may include one or more hard disk drives, solid state storage devices, and the like. System disk 406 is configured to store a database 418 of information associated with feature join engine 130, machine learning engine 140, and feature data sets 110.

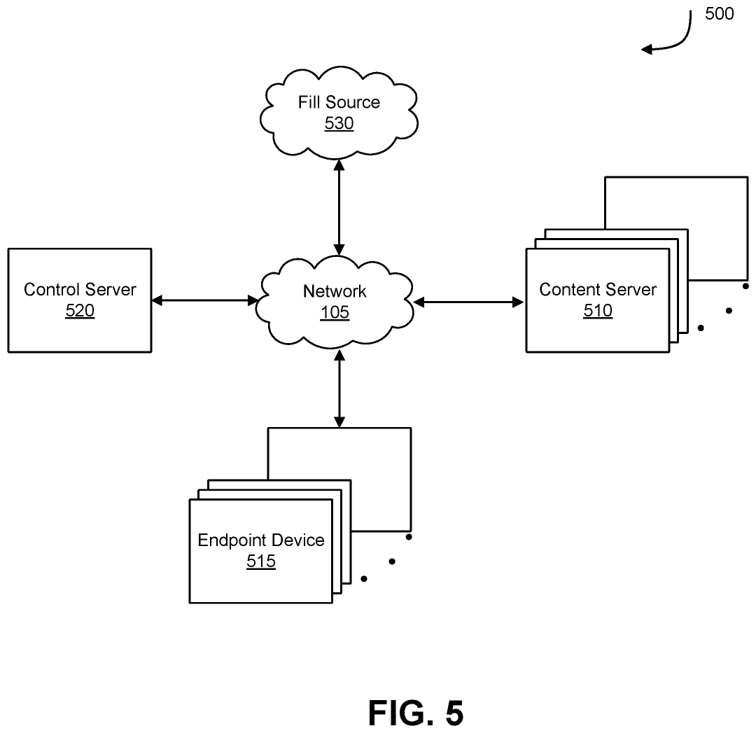

FIG. 5 illustrates a network infrastructure configured to implement one or more aspects of the various embodiments. As shown, network infrastructure 500 includes one or more content servers 510, a control server 520, and one or more endpoint devices 515, which are connected to one another and/or one or more fill source(s) 530 via communications network 105 described above in reference to FIG. 1. Network infrastructure 500 is generally used to distribute content to content servers 510 and endpoint devices 515. In various embodiments, streaming service 120 comprises network infrastructure 500 or portions thereof.

Each endpoint device 515 communicates with one or more content servers 510 (also referred to as “caches” or “nodes”) via network 105 to download content, such as textual data, graphical data, audio data, video data, and other types of data. The downloadable content, also referred to herein as a “file,” is then presented to a user of one or more endpoint devices 515. In various embodiments, endpoint devices 515 may include computer systems, set top boxes, mobile computer, smartphones, tablets, console and handheld video game systems, digital video recorders (DVRs), DVD players, connected digital TVs, dedicated media streaming devices, (e.g., the Roku® set-top box), and/or any other technically feasible computing platform that has network connectivity and is capable of presenting content, such as text, images, video, and/or audio content, to a user.

Each content server 510 may include one or more applications configured to communicate with control server 520 to determine the location and availability of various files that are tracked and managed by control server 520. Each content server 510 may further communicate with fill source(s) 530 and one or more other content servers 510 to “fill” each content server 510 with copies of various files. In addition, content servers 510 may respond to requests for files received from endpoint devices 515. The files may then be distributed from content server 510 or via a broader content distribution network. In some embodiments, content servers 510 may require users to authenticate (e.g., using a username and password) before accessing files stored on content servers 510. Although only a single control server 520 is shown in FIG. 1, in various embodiments multiple control servers 520 may be implemented to track and manage files.

In various embodiments, fill source(s) 530 may include an online storage service (e.g., Amazon® Simple Storage Service, Google® Cloud Storage, etc.) in which a catalog of files, including thousands or millions of files, is stored and accessed in order to fill content servers 510. Fill source(s) 530 also may provide compute or other processing services. Although only a single instance of fill source(s) 530 is shown in FIG. 1, in various embodiments multiple fill source(s) 530 and/or cloud service instances may be implemented.

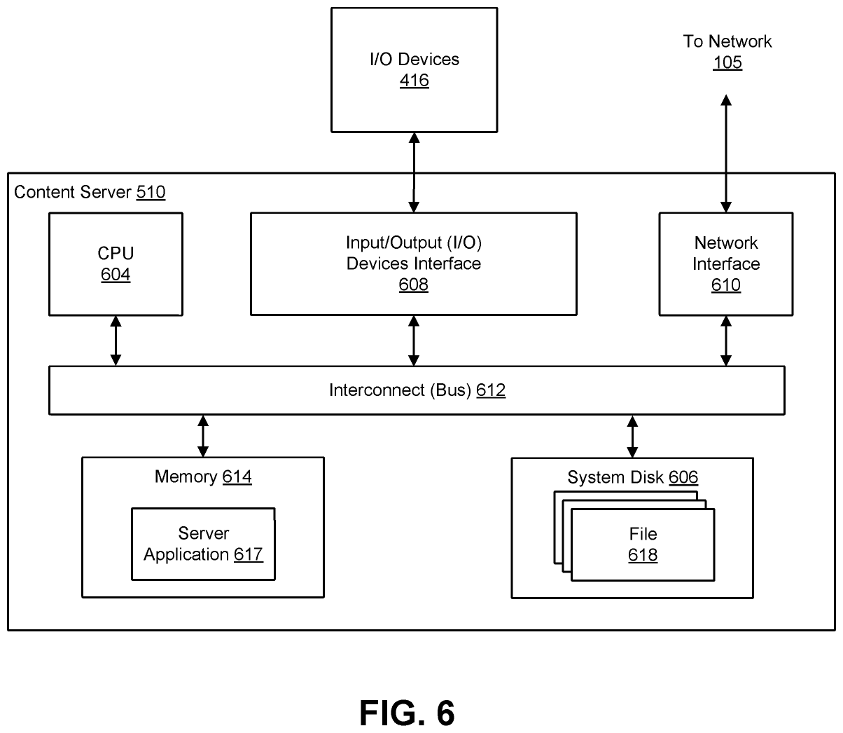

FIG. 6 is a block diagram of content server 510 that may be implemented in conjunction with the network infrastructure of FIG. 5, according to various embodiments. As shown, content server 510 includes, without limitation, a central processing unit (CPU) 604, a system disk 606, an input/output (I/O) devices interface 608, a network interface 610, an interconnect 612, and a system memory 614.

CPU 604 is configured to retrieve and execute programming instructions, such as a server application 617, stored in system memory 614. Similarly, CPU 604 is configured to store application data (e.g., software libraries) and retrieve application data from system memory 614. Interconnect 612 is configured to facilitate transmission of data, such as programming instructions and application data, between CPU 604, system disk 606, I/O devices interface 608, network interface 610, and system memory 614. I/O devices interface 608 is configured to receive input data from I/O devices 616 and transmit the input data to CPU 604 via interconnect 612. For example, I/O devices 616 may include one or more buttons, a keyboard, a mouse, and/or other input devices. I/O devices interface 608 is further configured to receive output data from CPU 604 via interconnect 612 and transmit the output data to I/O devices 616.

System disk 606 may include one or more hard disk drives, solid state storage devices, or similar storage devices. System disk 606 is configured to store non-volatile data such as files 618 (e.g., audio files, video files, subtitle files, application files, software libraries, etc.). Files 618 can then be retrieved by one or more endpoint devices 515 via network 105. In some embodiments, network interface 610 is configured to operate in compliance with the Ethernet standard.

System memory 614 includes server application 617, which is configured to service requests received from endpoint device 515 and other content servers 510 for one or more files 618. When server application 617 receives a request for a given file 618, server application 617 retrieves the requested file 618 from system disk 606 and transmits file 618 to an endpoint device 515 or a content server 510 via network 105. Files 618 include digital content items such as video files, audio files, and/or still images. In addition, files 618 may include metadata associated with such content items, user/subscriber data, etc. Files 618 that include visual content item metadata and/or user/subscriber data may be employed to facilitate the overall functionality of network infrastructure 500. In alternative embodiments, some or all of files 618 may instead be stored in a control server 520, or in any other technically feasible location within network infrastructure 500.

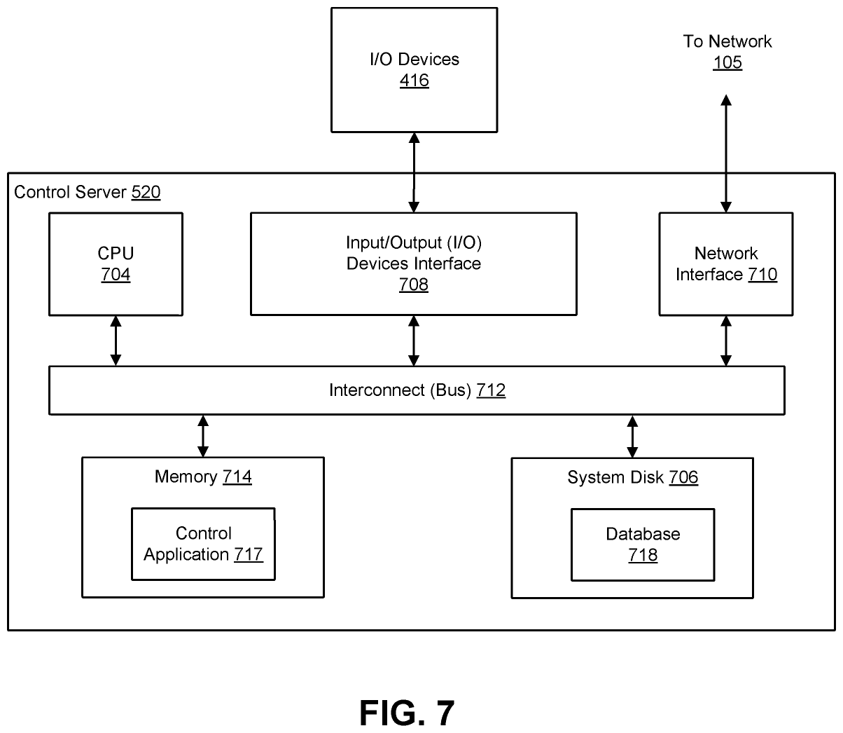

FIG. 7 is a block diagram of control server 520 that may be implemented in conjunction with the network infrastructure 500 of FIG. 5, according to various embodiments. As shown, control server 520 includes, without limitation, a central processing unit (CPU) 704, a system disk 706, an input/output (I/O) devices interface 708, a network interface 710, an interconnect 712, and a system memory 714.

CPU 704 is configured to retrieve and execute programming instructions, such as control application 717, stored in system memory 714. Similarly, CPU 704 is configured to store application data (e.g., software libraries) and retrieve application data from system memory 714 and a database 718 stored in system disk 706. Interconnect 712 is configured to facilitate transmission of data between CPU 704, system disk 706, I/O devices interface 708, network interface 710, and system memory 714. I/O devices interface 708 is configured to transmit input data and output data between I/O devices 416 and CPU 704 via interconnect 712. System disk 706 may include one or more hard disk drives, solid state storage devices, and the like. System disk 706 is configured to store a database 718 of information associated with content servers 510, fill source(s) 530, and files 618.

System memory 714 includes a control application 717 configured to access information stored in database 718 and process the information to determine the manner in which specific files 618 will be replicated across content servers 510 included in the network infrastructure 500. Control application 717 may further be configured to receive and analyze performance characteristics associated with one or more of content servers 510 and/or endpoint devices 515. As noted above, in some embodiments, metadata associated with such visual content items, and/or user/subscriber data may be stored in database 718 rather than in files 618 stored in content servers 510.

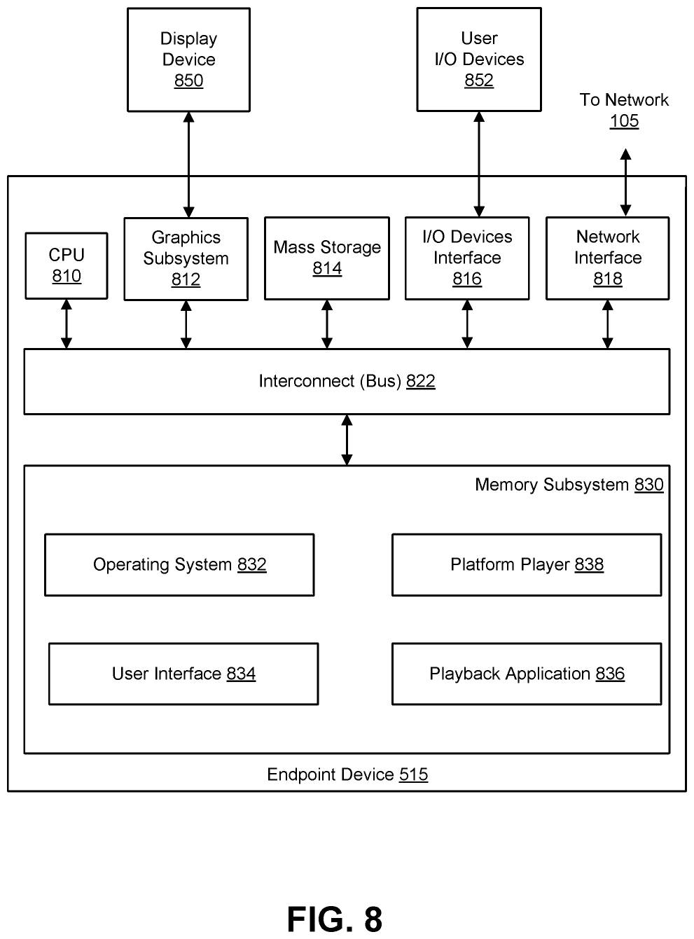

FIG. 8 is a block diagram of endpoint device 515 that may be implemented in conjunction with the network infrastructure of FIG. 5, according to various embodiments. As shown, endpoint device 515 may include, without limitation, a CPU 810, a graphics subsystem 812, an I/O devices interface 816, a mass storage unit 814, a network interface 818, an interconnect 822, and a memory subsystem 830.

In some embodiments, CPU 810 is configured to retrieve and execute programming instructions stored in memory subsystem 430. Similarly, CPU 810 is configured to store and retrieve application data (e.g., software libraries) residing in memory subsystem 830. Interconnect 822 is configured to facilitate transmission of data, such as programming instructions and application data, between CPU 810, graphics subsystem 812, I/O devices interface 816, mass storage unit 814, network interface 818, and memory subsystem 830.

In some embodiments, graphics subsystem 812 is configured to generate frames of video data and transmit the frames of video data to display device 850. In some embodiments, graphics subsystem 812 may be integrated into an integrated circuit, along with CPU 810. Display device 850 may comprise any technically feasible means for generating an image for display. For example, display device 850 may be fabricated using liquid crystal display (LCD) technology, cathode-ray technology, and light-emitting diode (LED) display technology. I/O devices interface 816 is configured to receive input data from user I/O devices 852 and transmit the input data to CPU 810 via interconnect 822. For example, user I/O devices 852 may include one or more buttons, a keyboard, and/or a mouse or other pointing device. I/O devices interface 816 also includes an audio output unit configured to generate an electrical audio output signal. User I/O devices 852 includes a speaker configured to generate an acoustic output in response to the electrical audio output signal. In alternative embodiments, display device 850 may include the speaker. Examples of suitable devices known in the art that can display video frames and generate an acoustic output include televisions, smartphones, smartwatches, electronic tablets, and the like.

A mass storage unit 814, such as a hard disk drive or flash memory storage drive, is configured to store non-volatile data. Network interface 818 is configured to transmit and receive packets of data via network 105. In some embodiments, network interface 818 is configured to communicate using the well-known Ethernet standard. Network interface 818 is coupled to CPU 810 via interconnect 822.

In some embodiments, memory subsystem 830 includes programming instructions and application data that include an operating system 832, a user interface 834, a playback application 836, and a platform player 838. Operating system 832 performs system management functions such as managing hardware devices including network interface 818, mass storage unit 814, I/O devices interface 816, and graphics subsystem 812. Operating system 832 also provides process and memory management models for user interface 834, playback application 836, and/or platform player 838. User interface 834, such as a window and object metaphor, provides a mechanism for user interaction with endpoint device 515. Persons skilled in the art will recognize the various operating systems and user interfaces that are well-known in the art and suitable for incorporation into endpoint device 515.

In some embodiments, playback application 836 is configured to request and receive content from content server 510 via network interface 818. Further, playback application 836 is configured to interpret the content and present the content via display device 850 and/or user I/O devices 852. In so doing, playback application 836 may generate frames of video data based on the received content and then transmit those frames of video data to platform player 838. In response, platform player 838 causes display device 850 to output the frames of video data for playback of the content on endpoint device 515. In one embodiment, platform player 838 is included in operating system 832.

In sum, the disclosed techniques include a feature join engine that generates a value for a machine learning feature based on an event, given a context including one or more contextual elements. Contextual elements may include a user's location, a user's profile, a time of day, an identification number associated with a user's device, or the user's current Internet Protocol (IP) address. The feature join engine includes a request engine, a partitioning engine, and one or more feature value engines.

In operation, the request engine receives a feature request from a requesting entity, where the feature request includes a machine learning feature and a context that includes one or more contextual elements. The request engine transmits the feature request to a partitioning engine, and the partitioning engine generates one or more sub-contexts based on the context included in the feature request. Each sub-context includes a distinct combination of one or more contextual elements from the context necessary to generate intermediate values that will be aggregated to calculate a requested value for the machine learning feature in the feature request. The partitioning engine may generate a sub-context for every possible combination of one or more contextual elements in the context. Thus, for an event having a context that contains N contextual elements, the partitioning engine may generate up to 2^{N}−1 distinct sub-contexts. The partitioning engine records the number of sub-contexts generated for the feature request, assigns a different sub-context to each of a plurality of feature value engines, and transmits each of the assigned sub-contexts to its associated feature value engine.

The request engine further receives an event from a computing system such as a streaming service. Examples of events include the presentation of a content item to a user, a search request submitted by a user, or a user logging into or out of a service. An event also includes as event data one or more contextual elements associated with the event.

The request engine randomly generates a unique event ID for the event and transmits the event data and the event ID to each of the feature value engines via the partitioning engine. The feature value engines process the event in parallel, and each feature value engine generates intermediate values for the requested machine learning feature that are based on or derivable from the contextual elements included in the sub-context assigned to the feature value engine. When generating intermediate values, each feature value engine may request historical data from a data store including feature data sets. Further, each feature value engine may perform calculations or conditional logic necessary to generate a feature value for a feature.

When a feature value engine completes generating intermediate values based on the event and the sub-context assigned to the feature value engine, the feature value engine transmits the results, including the generated intermediate values and the event ID associated with the event to the partitioning engine. The partitioning engine receives the transmitted results from the plurality of feature value engines.

When all of the feature value engines have returned their results for the event ID, the partitioning engine aggregates the results to generate a value for the machine learning feature included in the feature request. The partitioning engine transmits the value to the requesting entity via the request engine. The partitioning engine determines that all of the feature value engines have returned their results for a given event ID when the number of feature value engines that have returned results associated with the event ID is equal to the number of generated sub-contexts associated with the requested feature.

The request engine may further receive and process additional events, updating the value of the machine learning feature included in the feature request based on each additional event.

The disclosed techniques may generate feature values to be used as input to a trained machine learning model so that the trained machine learning model may perform an inference operation. The disclosed techniques may also generate historical feature values associated with a particular time. The disclosed techniques may generate, based on the historical feature values, a training data set of labeled or unlabeled scenario data for the purpose of training one or more machine learning models.

One technical advantage of the disclosed technique relative to the prior art is that the implementation processes sub-contexts in parallel, retrieving feature values for features associated with each of the sub-contexts simultaneously rather than sequentially. This parallel processing reduces the total time needed to retrieve feature values for features associated with the various sub-contexts, decreasing both the latency during operation and the time required to generate training data libraries for model training. These technical advantages provide one or more technological improvements over prior art approaches.

1. In some embodiments, a computer-implemented method for assigning values to machine learning features, the method comprising receiving, from a requesting entity, a machine learning feature and a context, generating a plurality of distinct sub-contexts based on the context, assigning each of the plurality of distinct sub-contexts to a different feature value engine of a plurality of feature value engines, assigning, via parallel operation of the plurality of feature value engines, intermediate values based on the plurality of distinct sub-contexts, receiving, from the plurality of feature value engines, the intermediate values, aggregating the intermediate values to generate a value for the machine learning feature, and transmitting the generated machine learning feature value to the requesting entity.

2. The computer-implemented method of clause 1, wherein the requesting entity comprises an upstream software application.

3. The computer-implemented method of clauses 1 or 2, further comprising receiving an event, wherein the event includes one or more contextual elements and one or more values associated with the contextual elements, generating a random event ID associated with the event, transmitting the event ID and the one or more contextual elements to each of the plurality of feature value engines, and associating the assigned intermediate values received from the plurality of feature value engines with the unique ID.

4. The computer-implemented method of any of clauses 1-3, further comprising repeatedly updating the value for the machine learning feature based on one or more additional received events.

5. The computer-implemented method of any of clauses 1-4, wherein the context includes one or more contextual elements, and a sub-context of the plurality of distinct sub-contexts includes a combination of the one or more of contextual elements included in the context.

6. The computer-implemented method of any of clauses 1-5, wherein the contextual elements include at least one of a user's location, a user's profile, a time of day, an identification number associated with a user's device, or a user's current Internet Protocol (IP) address.

7. The computer-implemented method of any of clauses 1-6, wherein generating the plurality of sub-contexts further comprises identifying a plurality of contextual elements included in the context, determining intermediate values necessary to calculate a value for the machine learning feature, determining one or more distinct combinations of contextual elements, wherein each distinct combination includes one or more contextual elements necessary to calculate one or more of the intermediate values, and identifying each of the one or more distinct combinations of contextual elements as a distinct sub-context.

8. The computer-implemented method of any of clauses 1-7, wherein a particular feature value engine assigns intermediate values based on data stored in one or more feature data sets.

9. The computer-implemented method of any of clauses 1-8, wherein the plurality of feature value engines are implemented as virtual machines (VMs).

10. In some embodiments, one or more non-transitory computer-readable media store instructions that, when executed by one or more processors, cause the one or more processors to perform the steps of receiving, from a requesting entity, a machine learning feature and a context, generating a plurality of distinct sub-contexts based on the context, assigning each of the plurality of distinct sub-contexts to a different feature value engine of a plurality of feature value engines, assigning, via parallel operation of the plurality of feature value engines, intermediate values based on the plurality of distinct sub-contexts, receiving, from the plurality of feature value engines, the intermediate values, aggregating the intermediate values to generate a value for the machine learning feature, and transmitting the generated machine learning feature value to the requesting entity.

11. The one or more non-transitory computer-readable media of clause 10, wherein the requesting entity comprises an upstream software application.

12. The one or more non-transitory computer-readable media of clauses 10 or 11, wherein the instructions further cause the one or more processors to perform the steps of receiving an event, wherein the event includes one or more contextual elements and one or more values associated with the contextual elements, generating a random event ID associated with the event, transmitting the event ID and the one or more contextual elements to each of the plurality of feature value engines, and associating the assigned intermediate values received from the plurality of feature value engines with the unique ID.

13. The one or more non-transitory computer-readable media of any of clauses 10-12, wherein the instructions further cause the one or more processors to perform the steps of repeatedly updating the value for the machine learning feature based on one or more additional received events.

14. The one or more non-transitory computer-readable media of any of clauses 10-13, wherein the context includes one or more contextual elements, and a sub-context of the plurality of distinct sub-contexts includes a combination of the one or more of contextual elements included in the context.

15. The one or more non-transitory computer-readable media of any of clauses 10-14, wherein the contextual elements include at least one of a user's location, a user's profile, a time of day, an identification number associated with a user's device, or a user's current Internet Protocol (IP) address.

16. The one or more non-transitory computer-readable media of any of clauses 10-15, wherein the instructions, when generating the plurality of distinct sub-contexts, cause the one or more processors to identify a plurality of contextual elements included in the context, determine intermediate values necessary to calculate a value for the machine learning feature, determine one or more distinct combinations of contextual elements, wherein each distinct combination includes one or more contextual elements necessary to calculate one or more of the intermediate values, and identify each of the one or more distinct combinations of contextual elements as a distinct sub-context.

17. The one or more non-transitory computer-readable media of any of clauses 10-16, wherein a particular feature value engine assigns intermediate values based on data stored in one or more feature data sets.

18. The one or more non-transitory computer-readable media of any of clauses 10-17, wherein the plurality of feature value engines are implemented as virtual machines (VMs).

19. In some embodiments, a computer-implemented method for generating machine learning training data, the computer-implemented method comprises receiving, from a machine learning engine, a machine learning feature and a context, generating a plurality of distinct sub-contexts based on the context, assigning each of the plurality of distinct sub-contexts to a different feature value engine of a plurality of feature value engines, assigning, via parallel operation of the plurality of feature value engines, intermediate values based on the plurality of sub-contexts, receiving, from the plurality of feature value engines, the intermediate values, aggregating the intermediate values to generate a value for the machine learning feature, and storing the machine learning feature and the generated value for the machine learning feature in a training data set.

20. The computer-implemented method of clause 19, wherein the context includes a timestamp that references a historical point in time.

Any and all combinations of any of the claim elements recited in any of the claims and/or any elements described in this application, in any fashion, fall within the contemplated scope of the present invention and protection.

The descriptions of the various embodiments have been presented for purposes of illustration but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for assigning values to machine learning features, the computer-implemented method comprising:
receiving, from a requesting entity, a machine learning feature and a context;
generating a plurality of distinct sub-contexts based on the context;
assigning each of the plurality of distinct sub-contexts to a different feature value engine of a plurality of feature value engines;
assigning, via parallel operation of the plurality of feature value engines, intermediate values based on the plurality of distinct sub-contexts;
receiving, from the plurality of feature value engines, the intermediate values;
aggregating the intermediate values to generate a value for the machine learning feature; and
transmitting the generated machine learning feature value to the requesting entity.

2. The computer-implemented method of claim 1, wherein the requesting entity comprises an upstream software application.

3. The computer-implemented method of claim 1, further comprising:
receiving an event, wherein the event includes one or more contextual elements and one or more values associated with the contextual elements;
generating a random event ID associated with the event;
transmitting the event ID and the one or more contextual elements to each of the plurality of feature value engines; and
associating the assigned intermediate values received from the plurality of feature value engines with the unique ID.

4. The computer-implemented method of claim 3, further comprising repeatedly updating the value for the machine learning feature based on one or more additional received events.

5. The computer-implemented method of claim 1, wherein the context includes one or more contextual elements, and a sub-context of the plurality of distinct sub-contexts includes a combination of the one or more of contextual elements included in the context.

6. The computer-implemented method of claim 5, wherein the contextual elements include at least one of a user's location, a user's profile, a time of day, an identification number associated with a user's device, or a user's current Internet Protocol (IP) address.

7. The computer-implemented method of claim 5, wherein generating the plurality of sub-contexts further comprises:
identifying a plurality of contextual elements included in the context;
determining intermediate values necessary to calculate a value for the machine learning feature;
determining one or more distinct combinations of contextual elements, wherein each distinct combination includes one or more contextual elements necessary to calculate one or more of the intermediate values; and
identifying each of the one or more distinct combinations of contextual elements as a distinct sub-context.

8. The computer-implemented method of claim 7, wherein a particular feature value engine assigns intermediate values based on data stored in one or more feature data sets.

9. The computer-implemented method of claim 1, wherein the plurality of feature value engines are implemented as virtual machines (VMs).

10. One or more non-transitory computer-readable media storing instructions that, when executed by one or more processors, cause the one or more processors to perform the steps of:
receiving, from a requesting entity, a machine learning feature and a context;
generating a plurality of distinct sub-contexts based on the context;
assigning each of the plurality of distinct sub-contexts to a different feature value engine of a plurality of feature value engines;
assigning, via parallel operation of the plurality of feature value engines, intermediate values based on the plurality of distinct sub-contexts;
receiving, from the plurality of feature value engines, the intermediate values;
aggregating the intermediate values to generate a value for the machine learning feature; and
transmitting the generated machine learning feature value to the requesting entity.

11. The one or more non-transitory computer-readable media of claim 10, wherein the requesting entity comprises an upstream software application.

12. The one or more non-transitory computer-readable media of claim 10, wherein the instructions further cause the one or more processors to perform the steps of:
receiving an event, wherein the event includes one or more contextual elements and one or more values associated with the contextual elements;
generating a random event ID associated with the event;
transmitting the event ID and the one or more contextual elements to each of the plurality of feature value engines; and
associating the assigned intermediate values received from the plurality of feature value engines with the unique ID.

13. The one or more non-transitory computer-readable media of claim 12, wherein the instructions further cause the one or more processors to perform the steps of repeatedly updating the value for the machine learning feature based on one or more additional received events.

14. The one or more non-transitory computer-readable media of claim 10, wherein the context includes one or more contextual elements, and a sub-context of the plurality of distinct sub-contexts includes a combination of the one or more of contextual elements included in the context.

15. The one or more non-transitory computer-readable media of claim 14, wherein the contextual elements include at least one of a user's location, a user's profile, a time of day, an identification number associated with a user's device, or a user's current Internet Protocol (IP) address.

16. The one or more non-transitory computer-readable media of claim 14, wherein the instructions, when generating the plurality of distinct sub-contexts, cause the one or more processors to:
identify a plurality of contextual elements included in the context;
determine intermediate values necessary to calculate a value for the machine learning feature;
determine one or more distinct combinations of contextual elements, wherein each distinct combination includes one or more contextual elements necessary to calculate one or more of the intermediate values; and
identify each of the one or more distinct combinations of contextual elements as a distinct sub-context.

17. The one or more non-transitory computer-readable media of claim 16, wherein a particular feature value engine assigns intermediate values based on data stored in one or more feature data sets.

18. The one or more non-transitory computer-readable media of claim 10, wherein the plurality of feature value engines are implemented as virtual machines (VMs).

19. A computer-implemented method for generating machine learning training data, the computer-implemented method comprising:
receiving, from a machine learning engine, a machine learning feature and a context;
generating a plurality of distinct sub-contexts based on the context;
assigning each of the plurality of distinct sub-contexts to a different feature value engine of a plurality of feature value engines;
assigning, via parallel operation of the plurality of feature value engines, intermediate values based on the plurality of sub-contexts;
receiving, from the plurality of feature value engines, the intermediate values;
aggregating the intermediate values to generate a value for the machine learning feature; and
storing the machine learning feature and the generated value for the machine learning feature in a training data set.

20. The computer-implemented method of claim 19, wherein the context includes a timestamp that references a historical point in time.
